(19) United States
(12) Patent Application Publication
(10) Pub. No.: US 2026/0146113 A1
(43) Pub. Date: May 28, 2026

(54) Ethylene-Based Polymers, Articles Made Therefrom, and Processes for Making Same

(71) Applicant: ExxonMobil Chemical Patents Inc., Spring, TX (US)

(72) Inventors: Martin ANTENSTEINER, Houston, TX (US); Michael LEAF, Baytown, TX (US); James SCHULZE, Humble, TX (US)

(21) Appl. No.: 18/874,044

(22) PCT Filed: May 24, 2023
(86) PCT No.: PCT/US2023/067413

§ 371 Date: Dec. 11, 2024

Related U.S. Application Data
(60) Provisional application No. 63/366,426, filed on Jun. 15, 2022.

(51) Int. Cl. C08F 210/02; C08J 5/18

(52) U.S. Cl. CPC C08F 210/02; C08J 5/18; C08F 2500/08; C08F 2500/12; C08F 2500/17; C08F 2800/10; C08J 2323/08

(57) ABSTRACT

Ethylene-based polymers, articles made therefrom, and processes for making same. The ethylene-based polymer can include polymer units derived from ethylene and polymer units derived from one or more C₃ to C₁₈ α-olefin monomers. The ethylene-based polymer can have a melt index (I₂) of 0.1 g/10 min to 10 g/10 min, a density of 0.890 g/cm³ to 0.910 g/cm³, a CDBI of 60% to 80%, a number average molecular weight of 25,000 g/mol to 53,000 g/mol, and an intrinsic viscosity of 1.3 dL/g to 1.9 dL/g. In some embodiments, the ethylene-based polymer can also have one or more of the following: a composition distribution breadth T₇₅-T₂₅ value, as measured by TREF, of 16.5° C. to 21° C., a complex viscosity measured at a shear rate of 10 rad/s of 5,700 Pa·s to 8,700 Pa·s, and a complex viscosity measured at a shear rate of 0.1 rad/s of 11,100 Pa·s to 14,100 Pa·s.

### CROSS-REFERENCE TO RELATED APPLICATION

This application claims the benefit of U.S. Provisional Application 63/366,426 filed Jun. 15, 2022, entitled “Ethylene-Based Polymers, Articles Made Therefrom, and Processes for Making Same”, the entirety of which is incorporated by reference herein.

### FIELD

The present disclosure relates to ethylene-based polymers, articles made therefrom, and processes for making same.

### BACKGROUND

Polymer films are desirable for many applications. Historically, such films are made with a blend of materials, and in particular include propylene-based polymers. The strength and success of polypropylene films is due to an excellent processability (broad stretching temperature profile, slow crystallization), good overall properties, attractive costs (high production speed), and good yield (low density).

More recently, however, interest has increased in developing simplified film solutions that utilize polyethylene, and preferably where substantially no polymers other than polyethylene or polyethylene-based polymers are present in the film layers (meaning that, for each polymer used in the film, the majority, e.g., 75% or more or 90% or more, of the polymers used in the film are polyethylene or polyethylene-based copolymers). Polyethylene, however, tends to have a higher crystallinity than polypropylene, making it more difficult to downgauge and maintain a suitable balance of stiffness and toughness characteristics.

There is a need, therefore, for improved ethylene-based polymers and articles made from same. This disclosure satisfies this and other needs.

### SUMMARY

Ethylene-based polymers, articles made therefrom, and processes for making same are provided. In some embodiments, the ethylene-based polymer can include about 90 mol % to about 99 mol % of polymer units derived from ethylene and about 1 mol % to about 10 mol % of polymer units derived from one or more C₃ to C₁₈ α-olefin monomers. The ethylene-based polymer can have a melt index (I₂, 190° C.) of about 0.1 g/10 min to about 10 g/10 min, a density of about 0.890 g/cm³ to about 0.910 g/cm³, a compositional distribution breadth index of about 60% to about 80%, a number average molecular weight of about 25,000 g/mol to about 53,000 g/mol, and an intrinsic viscosity of about 1.3 dL/g to about 1.9 dL/g. The ethylene-based polymer can also include one or more of the following: a composition distribution breadth T₇₅-T₂₅ value, as measured by TREF, of at least 16.5° C. to 21° C., a complex viscosity measured at a shear rate of 10 rad/s of at least 5,700 Pa·s to about 8,700 Pa·s, and a complex viscosity measured at a shear rate of 0.1 rad/s of at least 11,100 Pa·s to about 14,100 Pa·s.

In some embodiments, a process for making an ethylene-based polymer can include introducing ethylene and one or more C₃ to C₁₈ α-olefin monomers into a reactor and polymerizing the ethylene and the at least one other comonomer at a temperature of about 50° C. to about 110° C. and a pressure of about 750 kPa-absolute to about 7,000 kPa-absolute within the reactor to produce the ethylene-based polymer. The ethylene-based polymer can include about 90 mol % to about 99 mol % of polymer units derived from ethylene and about 1 mol % to about 10 mol % of polymer units derived from the one or more C₃ to C₁₈ α-olefin monomers. The ethylene-based polymer can have a melt index (I₂, 190° C.) of about 0.1 g/10 min to about 10 g/10 min, a density of about 0.890 g/cm³ to about 0.910 g/cm³, a compositional distribution breadth index of about 60% to about 80%, a number average molecular weight of about 25,000 g/mol to about 53,000 g/mol, and an intrinsic viscosity of about 1.3 dL/g to about 1.9 dL/g. In some embodiments, the ethylene-based polymer can also have one or more of the following: a composition distribution breadth T₇₅-T₂₅ value, as measured by TREF, of at least 16.5° C. to 21° C., a complex viscosity measured at a shear rate of 10 rad/s of at least 5,700 Pa·s to about 8,700 Pa·s, and a complex viscosity measured at a shear rate of 0.1 rad/s of at least 11,100 Pa·s to about 14,100 Pa·s.

### DETAILED DESCRIPTION

As used herein, the indefinite article “a” or “an” shall mean “at least one” unless specified to the contrary or the context clearly indicates otherwise. Thus, embodiments using “an alpha-olefin” include embodiments where one, two or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for acquiring the measurement.

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer.

A “polymer” has two or more of the same or different repeating units/mer units or simply units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “ethylene-based polymer”, “polyethylene copolymer”, “polyethylene”, “ethylene polymer”, and “ethylene copolymer” are used interchangeably to refer to a copolymer that includes at least 50 mol % of polymer units derived from ethylene, e.g., 90 mol % to 99 mol % of polymer units derived from ethylene.

The term “alpha-olefin” or “α-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6^{th} Edition, by F. Albert Cotton et al. (John Wiley & Sons, Inc., 1999).

### Ethylene-Based Polymers

### Composition, Density, Molecular Weights

The ethylene-based polymers disclosed herein refer to a polyethylene copolymer that can include 90 mol %, 91 mol %, 92 mol %, 93 mol %, or 94 mol % to 95 mol %, 96 mol %, 97 mol %, 98 mol %, or 99 mol % of polymer units derived from ethylene and about 1 mol %, 2 mol %, 3 mol %, 4 mol %, or 5 mol % to 6 mol %, 7 mol %, 8 mol %, 9 mol %, or 10 mol % of polymer units derived from one or more C₃ to C₁₈ α-olefin comonomers, preferably one or more C₃ to C₁₀ α-olefins, and more preferably one or more C₄ to C₈ α-olefins. The α-olefin comonomer can be linear or branched, and two or more comonomers can be used, if desired. Examples of suitable comonomers can be or can include, but are not limited to, propylene; 1-butene; 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. In some embodiments, particularly suitable comonomers can be or can include 1-butene, 1-hexene, and 1-octene.

The ethylene mol % and the comonomer mol % can be determined according using ¹³C NMR. More particularly, ¹³C NMR samples can be dissolved in deuterated 1,1,2,2-tetrachloroethane (tce-d2) at a concentration of 67 mg/mL at 140° C. Spectra can be recorded at 120° C. using a Bruker NMR spectrometer of at least 600 MHz with a 10 mm cryoprobe. A 900 pulse, 10 second delay, 512 transients, and gated decoupling can be used to measure the ¹³C NMR. Polymer resonance peaks can be referenced to polyethylene main peak at 29.98 ppm. Calculations involved in the characterization of polymers by NMR follow the work of J. Randall as disclosed in “Polymer Sequence Determination, 13C-NMR Method”, Academic Press, New York, 1977.

In some embodiments, the ethylene-based polymer can have a density of 0.870 g/cm³, 0.880 g/cm³, 0.890 g/cm³, 0.900 g/cm³, 0.903 g/cm³, or 0.905 g/cm³ to 0.907 g/cm³, 0.908 g/cm³, 0.909 g/cm³, 0.910 g/cm³, 0.912 g/cm³, 0.914 g/cm³, 0.916 g/cm³, 0.918, or 0.920 g/cm³. In other embodiments, the ethylene-based polymer can have a density of 0.900 g/cm³ to 0.910 g/cm³, 0.903 g/cm³ to 0.908 g/cm³, 0.904 g/cm³ to 0.906 g/cm³, or 0.904 g/cm³ to 9.905 g/cm³. The density of the ethylene-based polymer can be determined based on ASTM D1505-18, column density, with samples molded in accordance with ASTM D-4703-16, Procedure C, then conditioned under ASTM D-618-21 (23° C.+/−2° C. and 50+/−10% relative humidity) for 40 hours before testing.

In some embodiments, the ethylene-based polymer can have a number average molecular weight (Mn) of 20,000 g/mol, 23,000 g/mol, 25,000 g/mol 27,000 g/mol, 30,000 g/mol, 33,000 g/mol, or 35,000 g/mol to 37,000 g/mol, 40,000 g/mol, 42,000 g/mol, 45,000 g/mol, 50,000 g/mol, 53,000 g/mol, or 55,000 g/mol. In other embodiments, the ethylene-based polymer can have a number average molecular weight of 42,000 g/mol to 55,000 g/mol, 44,000 g/mol to 53,000 g/mol, 46,000 g/mol to 51,000 g/mol, or 47,000 g/mol to 50,000 g/mol. In still other embodiments, the ethylene-based polymer can have a number average molecular weight of greater than 42,000 g/mol, greater than 43,000 g/mol, greater than 44,000 g/mol, or greater than 45,000 g/mol to 49,000 g/mol, 50,000 g/mol, 51,000 g/mol, 52,000 g/mol, or 53,000 g/mol.

In some embodiments, the ethylene-based polymer can have a weight average molecular weight (Mw) of 90,000 g/mol, 100,000 g/mol, 110,000 g/mol, or 115,000 g/mol to 125,000 g/mol, 130,000 g/mol, 135,000 g/mol, or 140,000 g/mol. In other embodiments, the ethylene-based polymer can have a weight average molecular weight of greater than 100,000 g/mol, greater than 110,000 g/mol, greater than 115,000 g/mol, greater than 117,000 g/mol, or greater than 119,000 g/mol to 130,000 g/mol, 135,000 g/mol, or 140,000 g/mol.

In some embodiments, the ethylene-based polymer can have a z-average molecular weight (Mz) of 180,000 g/mol, 190,000 g/mol, or 200,000 g/mol to 220,000 g/mol, 230,000 g/mol, or 240,000 g/mol. In other embodiments, the ethylene-based polymer can have a weight average molecular weight of greater than 200,000 g/mol, greater than 205,000 g/mol, or greater than 207,000 g/mol to less than 240,000 g/mol, less than 230,000 g/mol, less than 220,000 g/mol, or less than 215,000 g/mol.

In some embodiments, the ethylene-based polymer can have a Mw/Mn value of 2.0, 2.1, 2.2, 2.3, or 2.4 to 2.5, 2.6, 2.7, 2.8, 2.9, or 3.0. In some embodiments, the ethylene-based polymer can have a Mz/Mw value of 1.3, 1.4, 1.5, 1.6, or 1.7 to 1.8, 1.9, 2.0, or 2.1. In some embodiments, the ethylene-based polymer can have a Mz/Mn value of 3.9, 4.0, 4.1, 4.2, or 4.3 to 4.4, 4.5, 4.6, 4.7, or 4.8.

The distribution and the moments of molecular weight (Mw, Mn, Mz, Mw/Mn, Mz/Mn, etc.) and the monomer/comonomer content (C₂, C₄, C₆ and/or C₈, and/or others, etc.), as well as g′(vis), for the ethylene-based polymers described herein are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles and methods for molecular weight determinations and g′(vis) are described in paragraphs [0044]-[0051] of PCT Publication WO2019/246069A1 (noting that the equation c=/// referenced in Paragraph [0044] therein for concentration (c) at each point in the chromatogram, is c=βI, where β is mass constant and I is the baseline-subtracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0045] of the just-noted publication), noting that for the equation in such Paragraph [0044], a=0.695 and K=0.000579(1-0.75 Wt) are used, where Wt is the weight fraction for comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of the just-noted PCT publication). Other parameters needed can be found in the referenced passage in the WO2019/246069A1 publication, but some are included here for convenience: n=1.500 for TCB at 145° C.; I=665 nm; dn/dc=0.1048 ml/mg.

### Composition Distribution and Crystallinity

Composition distribution (or comonomer distribution) refers to the distribution of comonomer, or short-chain branching (SCB), into polymer chains of different lengths (different molecular weights). Ethylene-based polymers of the present disclosure exhibit relatively constant or homogenous distribution of comonomer along chains of different length, with some variation evidenced.

For instance, the ethylene-based polymer can have a composition distribution breadth index (CDBI) within the range from a low of any one of 50%, 55%, 60%, 65%, 70%, 73%, or 74% to a high of any one of 75%, 76%, 77%, 80%, 85%, 90%, or 95%, with ranges from any foregoing low end to any foregoing high end contemplated (e.g., a CDBI of 60% to 80%, 65% to 80%, 70% to 80%, 73% to 77%, or 74% to 76%). CDBI is defined as the weight percent of the copolymer molecules having a comonomer content within 50% of the median total molar comonomer content (i.e., within +/−25% of the median), and it is referenced, e.g., in U.S. Pat. No. 5,382,630. In general, copolymers with a broader distribution (meaning a greater difference between (i) comonomer incorporation on high-molecular-weight polymer chains and (ii) comonomer incorporation on low-molecular-weight polymer chains) result in a lower CDBI, while a theoretical copolymer with exactly the same relative comonomer content across all different lengths of polymer chains within +/−25% of the median length (median molecular weight) would have a CDBI of 100%. The CDBI of a copolymer is readily determined utilizing a technique for isolating individual fractions of a sample of the copolymer. One such technique is generation of a solubility distribution curve using Temperature Rising Elution Fraction (TREF), as described in WO 1993003093 (which in turn references Wild, et al., J. Poly. Sci. Poly. Phys. Ed., vol. 20, p. 441 (1982) and U.S. Pat. No. 5,008,204 in this regard). All three of the foregoing publications are incorporated herein by reference.

The solubility distribution curve can be first generated for the copolymer using data acquired from TREF techniques (as described, e.g., in the just-referenced publications). This solubility distribution curve is a plot of the weight fraction of the copolymer that is solubilized as a function of temperature. This can be converted to a weight fraction versus composition distribution curve. For the purpose of simplifying the correlation of composition with elution temperature the weight fractions less than 15,000 can be ignored. These low weight fractions generally represent a trivial portion of the ethylene-based polymers disclosed herein.

Alternatively or additionally, the composition or comonomer distribution can be understood with reference to the T₇₅-T₂₅ value, wherein T₂₅ is the temperature at which 25% of the eluted polymer is obtained and T₇₅ is the temperature at which 75% of the eluted polymer is obtained, both in a TREF experiment (and plotting of eluted polymer weight percentages vs. elution temperatures) as described in US2019/0119413 (especially in paragraphs [0055]-[0058] thereof, which description is incorporated by reference herein). A narrow distribution is indicated by a relatively small difference in the T₇₅-T₂₅ value (and in particular in conjunction with a high CDBI value), while a broad distribution is reflected in a relatively larger difference in the T₇₅-T₂₅ value (and in particular in in conjunction with smaller CDBI value), implying greater differences in crystallinity between fractions of the polymer composition. It is also noted that, in the event of discrepancies between the actual TREF procedure as described in US2019/0119413 vs. the TREF procedure as described in WO 1993003093, U.S. Pat. Nos. 5,382,630, and/or 5,008,204, the TREF procedure as described in US2019/0119413 should be used. (Note further that the curves generated ancillary to the TREF procedures—solubility distribution curve for CDBI, and eluted weight percentages vs elution temperature for T₇₅-T₂₅, may have appropriate differences in their generation and analysis for CDBI and T₇₅-T₂₅.) Finally, the TREF curve (eluted polymer weight percentages vs elution temperatures) generated in connection with T₇₅-T₂₅ measurements can be further processed as follows:
1. The solvent-only response of the instrument can be generated and subtracted from the TREF curve of the sample. The solvent-only response can be generated by running, typically before, the same method as used for the polymer sample, but without any polymer added to the sample vial; using the same solvent reservoir as for the polymer sample and without replenishing with fresh solvent; and within a reasonable proximity of time from the run for the polymer sample.
2. The temperature axis of the TREF curve can be appropriately shifted to correct for the delay in the IR signal caused by the column-to-detector volume. This volume can be obtained by first filling the injection-valve loop with a ˜1 mg/ml solution of an HDPE resin; then loading the loop volume in the same location within the column where a sample is loaded for TREF analysis; then directly flowing, at a constant flow rate of 1 ml/min, the hot solution towards the detector using an isothermal method; and then measuring the time after injection for the HDPE probe's peak to appear in the IR signal. The delay volume (ml) is therefore equated to the time (min).
3. The curve can be baseline corrected and appropriate integration limits can be selected. And the curve can be normalized so that the area of the curve is 100 wt %.

In particular, the ethylene-based polymer can have T₇₅-T₂₅ value within the range from a low of any one of 16.5° C., 17° C., 17.5° C., 18° C., 18.5° C., or 19° C., to a high of any one of 19.5° C., 20° C., 20.5° C., or 21° C., with ranges from any foregoing low end to any foregoing high end contemplated herein, and also with ranges greater than or less than any of the foregoing end points contemplated herein (for instance, greater than 16.5° C., greater than 16.7° C., greater 16.9° C., or greater than 17° C. to less than 21° C., less than 20.5° C., less than 20° C., less than 19.5° C., or less than 19° C.).

Similarly, the known cryogenic cross fractionation (cryo CFC) equal halves analysis technique can be used to determine T_{W1}, T_{w2}, M_{W1}, and M_{W2} values. The cryo CFC method and determination of Tw1, Tw2, Mw1, Mw2 is described in U.S. Patent Application Publication No. US2022/0048016 (Paragraphs 622-634 and FIGS. 2-3 therein), incorporated herein by reference. Summarizing from that publication, Tw1 and Tw2 represent: the average temperature at which the first half of polymer eluted (Tw1) and the average temperature at which the second half (Tw2) eluted during the CFC experiment, noting that higher temperature of elution infers greater crystallinity; ergo, the temperatures Tw1 and Tw2 can be used to infer the presence of two distinctly crystalline fractions, and the difference between these can be used to infer the difference in degree of crystallinity among those fractions. Mw1 and Mw2 represent the average weight-average molecular weights of the first (Mw1) and second (Mw2) fractions of eluting polymer, which can be used to infer the relative amounts of lower- and higher-crystallinity fraction in the polymer.

In some embodiments, the ethylene-based polymer can have a T_{W1} value of 50° C., 51° C., 52° C., 53° C., 54° C. 55° C., 56° C. to 57° C., 58° C., 59° C., 60° C., or 61° C. In some embodiments, the ethylene-based polymer can have a T_{W2} value of 74° C., 75° C., 76° C., 77° C., or 78° C. to 79° C., 80° C., 81° C., 82° C., or 83° C. In some embodiments, the ethylene-based polymer can have a Tw₁-Tw₂ value of −7° C., −9° C., −11° C., −13° C., −15° C., or −17° C., to −19° C., −21° C., −22° C., −23° C., −24° C., or −25° C. In some embodiments, the Tw₁-Tw₂ value can be less than −21.5° C., less than −21.7° C., or less than −22° C. and greater than −23° C., greater than −22.7° C., or greater than −22.5° C.

In some embodiments, the ethylene-based polymer can have a M_{W1} value of 160,000 g/mol, 165,000 g/mol, 170,000 g/mol, or 175,000 g/mol to 180,000 g/mol, 185,000 g/mol, 190,000 g/mol, or 195,000 g/mol. In some embodiments, the ethylene-based polymer can have a Mw₂ value of 170,000 g/mol, 175,000 g/mol, 180,000 g/mol, or 185,000 g/mol to 190,000 g/mol, 195,000 g/mol, 200,000 g/mol, or 205,000 g/mol. In some embodiments, the ethylene-based polymer can have a Mw₁/Mw₂ value of 0.6, 0.7, 0.8, 0.9, or 1 to 1.3, 1.4, 1.5 1.6, or 1.7.

### Rheology of the Ethylene-Based Polymer

In some embodiments, the ethylene-based polymer can have a melt index (MI, or I₂) of 0.1 g/10 min, 0.2 g/10 min, 0.4 g/10 min, 0.6 g/10 min, 0.8 g/10 min, or 1 g/10 min to 2 g/10 min, 4 g/10 min, 6 g/10 min, 8 g/10 min, or 10 g/10 min, as measured in accordance with ASTM D-1238-20 under a load of 2.16 kg and at a temperature of 190° C. (I₂, 190° C.). In other embodiments, the ethylene-based polymer can have a melt index (I₂) of 0.1 g/10 min, 0.2 g/10 min, 0.3 g/10 min, 0.4 g/10 min, 0.5 g/10 min, or 0.6 g/10 min to 0.7 g/10 min, 0.8 g/10 min, or 0.85 g/10 min, 0.9 g/10 min, or 1 g/10 min. In still other embodiments, the ethylene-based polymer can have a melt index (I₂) of 0.1 g/10 min to less than 0.8 g/10 min. In some embodiments, the ethylene-based polymer can have a high-load melt index (HLMI, or I₂₁) of 5 g/10 min, 7 g/10 min, 9 g/10 min, or 11 g/10 min to 13 g/10 min, 14 g/10 min, 15 g/10 min, or 16 g/10 min, as measured in accordance with ASTM D-1238-20 under a load of 21.6 kg and at a temperature of 190° C. (I₂₁, 190° C.). The melt index ratio (MIR, defined as the ratio I_{21.6}/I_{2.16}) of the ethylene-based polymer can be from 10, 12, or 14 to 16, 18, or 20.

The ethylene-based polymer can also or instead have an intrinsic viscosity of 1.3 dL/g, 1.35 dL/g, 1.4 dL/g, 1.45 dL/g, 1.5 dL/g, 1.55 dL/g, 1.6 dL/g or 1.65 dL/g to 1.7 dL/g, 1.75 dL/g, 1.8 dL/g, 1.85 dL/g, or 1.9 dL/g. In other embodiments, the ethylene-based polymer can have an intrinsic viscosity of greater than 1.4 dL/g, greater than 1.5 dL/g, greater than 1.6 dL/g, or greater than 1.7 dL/g to 1.75 dL/g, 1.8 dL/g, 1.85 dL/g, or 1.9 dL/g. The intrinsic viscosity of the ethylene-based polymers can be determined according to the procedure described in Macromolecules, 2000, 33, pp. 7489-7499. Intrinsic viscosity can be determined by dissolving the linear and branched polymers in an appropriate solvent, e.g., trichlorobenzene, typically measured at 135° C. Another method for measuring the intrinsic viscosity of the ethylene-based polymers can include ASTM D-5225-98 Standard Test Method for Measuring Solution Viscosity of Polymers with a Differential Viscometer. In the event that results obtained from the two methods conflict, results from the methods following ASTM D-5225-98 should control.

The ethylene-based polymer can have a Dow Rheology Index (DRI)/melt index (I₂, 190° C.) ratio of at least 0.060, at least 0.061, at least 0.062, or at least 0.063 to less than 0.070, less than 0.075, or less than 0.080. The Dow Rheology Index can be measured according to the well-known technique described in PCT Publication WO2013/087531A1.

Further rheology properties can be characterized using small angle oscillatory shear (SAOS) measurements, recording viscosity at various shear rates.

For instance, the ethylene-based polymer can have a complex viscosity measured at a shear rate of 100 rad/s of 1,500 Pa·s, 1,600 Pa·s, 1,800 Pa·s, 2,000 Pa·s, 2,300 Pa·s, or 2,500 Pa·s to 2,700 Pa·s, 2,900 Pa·s, 3,100 Pa·s, 3,300 Pa·s, or 3,500 Pa·s (again, with ranges from any foregoing low end to any foregoing high end contemplated herein). Alternatively, the ethylene-based polymer can be characterized in terms of minimum complex viscosity at 100 rad/s shear rate, with no maximum necessarily required; for instance, complex viscosity at 100 rad/s shear rate can be at least 2,600 Pa·s, at least 2,700 Pa·s, at least 2,800 Pa·s, or at least 2,900 Pa·s to 3,100 Pa·s, 3,300 Pa·s, or 3,500 Pa·s.

The ethylene-based polymer can also or instead be characterized by complex viscosities at other shear rates. For example, complex viscosity measured at a shear rate of 10 rad/s can be within the range from a low of any one of 5,700 Pa·s, 6,000 Pa·s. 6,300 Pa·s. 6,500 Pa·s, 6,700 Pa·s, or 7,000 Pa·s to a high end of any one of 7,300 Pa·s, 7,500 Pa·s, 7,700 Pa·s, 8,000 Pa·s, 8,300 Pa·s, 8,500 Pa·s, or 8,700 Pa·s. Also or instead, complex viscosity measured at 1 rad/s shear rate can be within the range from a low of any one of 3,600 Pa·s, 4,000 Pa·s, 5,000 Pa·s, 6,000 Pa·s, 7,000 Pa·s, 8,000 Pa·s, or 9,000 Pa s to ahigh of any one of 10,000 Pa·s, 11,000 Pa·s, 12.00 Pa·s, 13,000, or 13,300 Pa·s. Similarly, complex viscosity at 1 rad/s shear rate can be characterized in terms of minima rather than ranges, e.g., the ethylene-based polymer can have a complex viscosity measured at a shear rate of 1 rad/s of at least 7,100 Pa·s, at least 7,500 Pa·s, at least 8,000 Pa·s, at least 8,500 Pa·s, at least 9,000 Pa·s, or at least 9,500 Pa·s to 10,000 Pa·s, 11,000 Pa·s, 12.00 Pa·s, 13,000, or 13,300 Pa·s. Finally, in addition to or instead of any one or more of the foregoing, the ethylene-based polymer can have a complex viscosity measured at a shear rate of 0.1 rad/s within the range from a low of any one of 11,100 Pa·s, 11,150 Pa·s, 11,200, or 11,250 Pa·s to ahigh of any one of 11,500 Pa·s, 12,000 Pa·s, 12,500 Pa·s, 13.00 Pa·s, 13,500, or 14,100 Pa·s.

As alluded to above, the complex viscosity of the ethylene-based polymer can be measured via small angle oscillatory shear (SAOS) at various shear rates, and in particular, at a shear rate of 10^{x}. For example, Eta*10² is the complex viscosity measured at a shear rate of 100 rad/sec. Small angle oscillatory shear (“SAOS”) frequency sweep melt rheology experiments were performed at 190° C. using a 25 mm cone)(1° and plate configuration on a MCR301 controlled strain/stress rheometer (Anton Paar GmbH). Sample test disks (25 mm diameter, 1 mm thickness) were prepared via compression molding of pellets (which where necessary can be made from fiber samples) at 190° C. using a Schwaben Than laboratory press (200T). Typical cycle for sample preparation is 1 minute without pressure followed by 1.5 minute under pressure (50 bars) and then cooling during 5 minutes between water cooled plates. The sample was first equilibrated at 190° C. for 13 min to erase any prior thermal and crystallization history. An angular frequency sweep was next performed from 500 rad/s to 0.0232 rad/s using 6 points/decade and a strain value of 10% lying in the linear viscoelastic region determined from strain sweep experiments. All experiments were performed in a nitrogen atmosphere to minimize any degradation of the sample during rheological testing.

### Processes for Making the Ethylene-Based Polymer

While any suitable polymerization method (including solution or slurry polymerization methods) can be used, the ethylene-based polymers disclosed herein can be readily obtained via a continuous gas phase polymerization using a supported catalyst that can include an activated molecularly discrete catalyst in the substantial absence of an aluminum alkyl based scavenger (e.g., triethylaluminum (TEAL), trimethylaluminum (TMAL), triisobutyl aluminum (TIBAL), tri-n-hexylaluminum (TNHAL), and the like).

In some embodiments, the ethylene-based polymer can be made with zirconium transition metal metallocene-type catalyst systems. Non-limiting examples of metallocene catalysts and catalyst systems useful that can be used to make the ethylene-based polymer can include those described in U.S. Pat. Nos. 5,466,649, 6,476,171, 6,225,426, and 7,951,873 and in the references cited therein.

The polymerization catalyst can be deposited on, bonded to, contacted with, or incorporated within, adsorbed or absorbed in or on a support or carrier. In another embodiment, the metallocene can be introduced onto a support by slurrying a pre-supported activator in oil, a hydrocarbon such as pentane, solvent, or non-solvent, then adding the metallocene as a solid while stirring. The metallocene can be finely divided solids. Although the metallocene is typically of very low solubility in the diluting medium, the metallocene can distribute onto the support and be active for polymerization. Very low solubilizing media such as mineral oil (e.g., Kaydo™ or Drakol™) or pentane can be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

Typically in a gas phase polymerization process, a continuous cycle is employed where in one part of the cycle of a reactor, a cycling gas stream, otherwise known as a recycle stream or fluidizing medium, is heated in the reactor by the heat of polymerization. This heat can be removed in another part of the cycle by a cooling system external to the reactor. (See for example, U.S. Pat. Nos. 4,543,399, 4,588,790, 5,028,670, 5,317,036, 5,352,749, 5,405,922, 5,436,304, 5,453,471, 5,462,999, 5,616,661, and 5,668,228)

Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and at least a portion of the gaseous stream withdrawn from the fluidized bed can be recycled back into the reactor. Simultaneously, polymer product can be withdrawn from the reactor and fresh monomer can be added to replace the polymerized monomer. The reactor pressure can vary from 680 kPa-absolute, 750 kPa-absolute, 1,000 kPa-absolute, 1,500 kPa-absolute, or 2,000 kPa-absolute to 4,000 kPa-absolute, 5,500 kPa-absolute, or 7,000 kPa-absolute. The reactor can be operated at a temperature in the range of 50° C., 60° C., 70° C., 75° C., or 80° C. to 85° C., 90° C., 95° C., 100° C., 110° C., or 120° C. The productivity of the catalyst or catalyst system can be influenced by the main monomer partial pressure. The mole percent of the main monomer, ethylene, can be from 25 mol %, 50 mol %, or 70 mol % to 80 mol %, 85 mol %, or 90 mol % and the monomer partial pressure can be in the range of 500 kPa-absolute, 690 kPa-absolute, 1,025 kPa-absolute, or 1,375 kPa-absolute to 1,700 kPa-absolute, 1,800 kPa-absolute, 1,900 kPa-absolute, or 2,100 kPa-absolute, which are typical conditions in a gas phase polymerization process.

Other gas phase processes that can be used to make the ethylene-based polymer can include those described in U.S. Pat. Nos. 5,627,242, 5,665,818, and 5,677,375, and European Patent Application Nos. EP-A-0 794 200, EP-A-0 802 202, and EP-B-634 421.

In some embodiments, it can be beneficial in slurry or gas phase processes to operate in the substantial absence of or essentially free of any scavengers, such as triethylaluminum, trimethylaluminum, triisobutylaluminum, and tri-n-hexylaluminum and diethyl aluminum chloride and the like. Such processes are described in PCT Publication No. WO 96/08520.

Additionally, the use of a process continuity aid, while not required, can be desirable in any of the foregoing processes. Such continuity aids are well-known to persons of skill in the art and include, for example, metal stearates.

### End-Use Applications

Some properties of the ethylene-based polymers described herein can be characterized by their performance in films. End-use applications of such films include, e.g., monolayer and multilayer blown, extruded, and/or cast films. Films including the ethylene-based polymer are also useful as cling film, sealing films, oriented films, snack packaging, heavy duty bags, grocery sacks, baked and frozen food packaging, medical packaging, industrial liners, membranes, etc., in food-contact and non-food contact applications. The combination of properties provided by the ethylene-based polymer particularly lend films, particularly blown films, made therefrom to use in sealing film applications.

The total thickness of monolayer and multilayer films can vary based upon the application desired. A total film thickness of 5 μm to 100 μm, more typically 10 μm to 25 μm, is suitable for most applications. Those skilled in the art will appreciate that the thickness of individual layers for multilayer films can be adjusted based on desired end-use performance, resin or copolymer employed, equipment capability, and other factors. The materials forming each layer can be coextruded through a coextrusion feed block and die assembly to yield a film with two or more layers adhered together but differing in composition. Coextrusion can be adapted for use in both cast film or blown film processes.

Particular embodiments disclosed herein include monolayer films that include the ethylene-based polymer disclosed herein. When used in multilayer films, the ethylene-based polymer can be used in any layer of the film, or in more than one layer of the film, as desired. When more than one layer of the film includes an ethylene-based polymer, each such layer can be individually formulated; i.e., the layers that include the ethylene-based polymer can be the same or different in chemical composition, density, melt index, thickness, etc., depending, at least in part, on the desired properties of the film.

Such films can be formed by any number of well-known extrusion or coextrusion techniques discussed below. Films may be unoriented, uniaxially oriented or biaxially oriented. As described below, the films can be cast films or blown films. The films can further be embossed, or produced, or processed according to other known film processes. The films can be tailored to specific applications by adjusting the thickness, materials and order of the various layers, as well as the additives in or modifiers applied to each layer.

Films can be formed by using casting techniques, such as a chill roll casting process. For example, a composition can be extruded in a molten state through a flat die and then cooled to form a film. As a specific example, cast films can be prepared using a cast film line machine as follows. Pellets of the polymer are melted at a temperature typically ranging from about 250° C. to about 300° C. for cast ethylene-based polymers (depending upon the particular resin used), with the specific melt temperature being chosen to match the melt viscosity of the particular resin layers. In the case of a multilayer cast film, the two or more different melts are conveyed to a coextrusion adapter that combines the two or more melt flows into a multilayer, coextruded structure. This layered flow is distributed through a single manifold film extrusion die to the desired width. The die gap opening is typically about 600 μm. The material is then drawn down to the final gauge. The material draw down ratio is typically about 21:1 for 20 μm films. A vacuum box, edge pinners, air knife, or a combination of the foregoing can be used to pin the melt exiting the die opening to a primary chill roll maintained at about 32° C. The resulting polymer film is collected on a winder. The film thickness can be monitored by a gauge monitor and the film can be edge trimmed by a trimmer. A typical cast line rate is from about 76.2 meters per minute to about 609.6 meters per minute. One skilled in the art will appreciate that higher rates may be used for similar processes such as extrusion coating. One or more optional treaters can be used to surface treat the film, if desired. Such chill roll casting processes and apparatus are well-known in the art and are described, for example, in The Wiley-Encyclopedia of Packaging Technology, Second Edition, A. L. Brody and K. S. Marsh, Ed., John Wiley and Sons, Inc., New York (1997). Although chill roll casting is one example, other forms of casting may be employed.

Films containing the ethylene-based polymers described herein can be formed using blown techniques, i.e., to form a blown film. For example, the composition can be extruded in a molten state through an annular die and then blown and cooled to form a tubular, blown film, which can then be axially slit and unfolded to form a flat film. As a specific example, blown films can be prepared as follows. The polymer composition is introduced into the feed hopper of an extruder, such as a 63.5 mm Egan extruder that is water-cooled, resistance heated, and has a L/D ratio of 24:1. The film can be produced using a 15.24 cm Sano die with a 2.24 mm die gap, along with a Sano dual orifice non-rotating, non-adjustable air ring. The film is extruded through the die into a film cooled by blowing air onto the surface of the film. The film is drawn from the die typically forming a cylindrical film that is cooled, collapsed, and optionally subjected to a desired auxiliary process, such as slitting, treating, sealing, or printing. Typical melt temperatures are from about 175° C. to about 225° C. Blown film rates are generally from about 2.27 kg to about 13.61 kg per hour per 2.54 cm of die circumference. The finished film can be wound into rolls for later processing or can be fed into a bag machine and converted into bags. A particular blown film process and apparatus suitable for forming films according to embodiments described herein are described in U.S. Pat. No. 5,569,693. Of course, other blown film forming methods can also be used.

Some films including the ethylene-based polymers described herein can be characterized by unique properties particularly suited to heat sealing applications. The properties of blown films made from the ethylene-based polymer can be measured on blown films that had a thickness of about 25.4 μm. As such, the properties of a blown film made from the ethylene-based polymer disclosed herein are for blown films having a thickness of about 25.4 μm.

In some embodiments, a blown film made from the ethylene-based polymer can have a hot tack force greater than 4 N/25 mm, greater than 4.5 N/25 mm, greater than 5 N/25 mm, greater than 5.5 N/25 mm, greater than 6 N/25 mm, greater than 6.5 N/25 mm, greater than 7 N/25 mm, greater than 7.5 N/25 mm, or greater than 8 N/25 mm at temperatures between 85° C. and 90° C. In some embodiments, a blown film made from the ethylene-based polymer can have a hot tack force greater than 4 N/25 mm up to 8.5 N/25 mm at temperatures between 85° C. and 90° C. The hot tack force for the blown film made from the ethylene-based polymer can be measured according to the following procedure. A 2.54 cm strip of film can be sealed at various temperatures under a pressure of 0.5 N/mm² for 0.5 seconds. After a 0.4 second delay, the sealed specimen can be pulled at 200 mm/min speed in T-joint peel mode.

In some embodiments, a blown film made from the ethylene-based polymer can have a seal strength of greater than 2 N, greater than 3 N, greater than 4N, greater than 5 N, greater than 6 N, greater than 7 N, greater than 8 N, or greater than 9 N at a seal temperature of about 70° C. to about 100° C. In other embodiments, a blown film made from the ethylene-based polymer can have a seal strength of greater than 2 N, greater than 3 N, greater than 4N, greater than 5 N, greater than 6 N, greater than 7 N, or greater than 8 N to 8.3N, 8.5 N, 8.7 N, or 9 N at a seal temperature of about 70° C. to about 100° C. In other embodiments, a blown film made from the ethylene-based polymer can have a seal strength of greater than 2 N, greater than 2.3 N, greater than 2.5N, greater than 2.7 N, greater than 3 N, greater than 3.3 N, greater than 3.5 N, or greater than 4 N at a seal temperature of about 72° C. to 75° C. In other embodiments, a blown film made from the ethylene-based polymer can have a seal strength of greater than 2, greater than 2.3 N, greater than 2.5N, greater than 2.7 N, greater than 3 N, greater than 3.3 N, or greater than 3.5 N to 3.7 N, 4 N, 4.2 N, 4.4 N, 4.6N, or 5 N at a seal temperature of about 72° C. to 75° C. The seal strength of the blown film made from the ethylene-based polymer can be measured according to the following procedure. A 2.54 cm strip of film can be sealed at various temperatures under a pressure of 0.5 N/mm² for 1 second. The film can then be conditioned according to ASTM D618-21 for 40 hours at 23° C.+/−2° C. and 50+/−10% relative humidity. The conditioned sealed specimen can then be tested in T-joint peel mode at 50.8 cm/min pulling speed.

In some embodiments, a blown film made from the ethylene-based polymer can have a tensile break strength in the machine direction of 50 MPa, 55 MPa, 60 MPa, 65 MPa, or 70 MPa to 75 MPa, 80 MPa, or 85 MPa. In other embodiments, a blown film made from the ethylene-based polymer can have a tensile break strength in the machine direction that can be greater than 77 MPa, greater than 78 MPa, greater than 79 MPa, or greater than 80 MPa to 81 MPa, 82 MPa, 83 MPa, 84 MPa, or 85 MPa. In some embodiments, a blown film made from the ethylene-based polymer can have a tensile break strength in the transverse direction of 50 MPa, 55 MPa, 60 MPa, 65 MPa, or 70 MPa to 75 MPa, 80 MPa, 85 MPa, or 90 MPa. In other embodiments, a blown film made from the ethylene-based polymer can have a tensile break strength in the transverse direction that can be greater than 65 MPa, greater than 67 MPa, greater than 70 MPa, greater than 72 MPa, or greater than 74 MPa to 75 MPa, 80 MPa, 85 MPa, or 90 MPa. The tensile break strength can be measured according to ASTM D-822-18, modified by using a 2.54 mm×17.78 cm strip at a speed of 50.8 cm/min.

In some embodiments, a blown film made from the ethylene-based polymer can have a tensile yield strength in the machine direction of 4.5 MPa, 4.7 MPa, 5.0 MPa, 5.1 MPa, or 5.3 MPa to 5.5 MPa, 5.7 MPa, 6 MPa, or 6.3 MPa. In some embodiments, a blown film made from the ethylene-based polymer can have a tensile yield strength in the transverse direction of 4.3 MPa, 4.5 MPa, 4.7 MPa, or 4.9 MPa to 5.1 MPa, 5.3 MPa, 5.4 MPa, or 5.5 MPa. The tensile yield strength can be measured according to ASTM D-822-18, modified by using a 2.54 mm×17.78 cm strip at a speed of 50.8 cm/min.

In some embodiments, a blown film made from the ethylene-based polymer can have a haze of 1%, 1.5%, 2%, 2.5%, 3%, or 4% to 8%, 10%, 12%, 14%, 16%, 18%, or 20%. In other embodiments, a blown film made from the ethylene-based polymer can have a haze of 1% to less than 2%, less than 1.9%, less than 1.8%, less than 1.7%, less than 1.6%, or less than 1.5%. The haze of the blown film can be measured according to ASTM D-1003-13.

In some embodiments, a blown film made from the ethylene-based polymer can have an average gloss of 10 GU, 15 GU, 20 GU, 25 GU, 30 GU, 35 GU, or 40 GU to 50 GU, 55 GU, 60 GU, 65 GU, 70 GU, 75 GU, 80 GU, 85 GU, or 90 GU. In other embodiments, a blown film made from the ethylene-based polymer can have an average gloss of greater than 80 GU, greater than 82 GU, greater than 83 GU, or greater than 84 GU to 86 GU, 88 GU, or 90 GU. The gloss of the blown film can be measured according to ASTM D2457-13. The gloss of the blown film sample can be measured in both the machine direction (MD) and the transverse directions (TD) direction the average being the MD value plus the TD value divided by 2.

In some embodiments, a blown film made from the ethylene-based polymer can have a puncture peak force per 25.4 μm of 1,800 kN/m, 1,900 kN/m, 2,000 kN/m, 2,100 kN/m, 2,200 kN/m, 2,300 kN/m, 2,400 kN/m, 2,500 kN/m, or 2,600 kN/m to 2,700 kN/m, 2,800 kN/m 2,900 kN/m, or 3,000 kN/m. In other embodiments, a blown film made from the ethylene-based polymer can have a puncture peak force per 25.4 m of greater than 2,400 kN/m, greater than 2,500 kN/m, greater than 2,600 kN/m, or greater than 2,670 kN/m to 2,800 kN/m, 2,900 kN/m, or 3,000 kN/m. The puncture peak force of the blown film can be measured according to ASTM D5748-19, modified by using a 19.05 mm stainless steel uncoated probe with two 6.35 m HDPEW slip sheets at a testing speed of 25.4 cm/minute.

In some embodiments, a blown film made from the ethylene-based polymer can have a puncture break energy of 130 kJ/m, 150 kJ/m, 175 kJ/m, or 200 kJ/m to 210 kJ/m, 230 kJ/m, 250 kJ/m, or 260 U/m. In other embodiments, a blown film made from the ethylene-based polymer can have a puncture break energy of greater than 252 kJ/m or greater than 253 kJ/m to 255 kJ/m, 257 kJ/m, or 260 kJ/m. The puncture break energy can be measured according to ASTM D5748-19.

In some embodiments, a blown film made from the ethylene-based polymer can have a machine direction (MD) Elmendorf Tear of 30 kN/m, 40 kN/m, 50 kN/m, 60 kN/m, or 70 kN/m to 80 kN/m, 90 kN/m, 100 kN/m, or 110 kN/m. In other embodiments, a blown film made from the ethylene-based polymer can have a machine direction Elmendorf Tear of 30 kN/m, 33 kN/m, 35 kN/m, 37 kN/m, or 39 kN/m to 42 kN/m, 43 kN/m, 44 kN/m, 45 kN/m, 46 kN/m, or 47 kN/m. In some embodiments, a blown film made from the ethylene-based polymer can have a machine direction Elmendorf Tear of less than 48 kN/m, less than 47 kN/m, less than 46 kN/m, or less than 45 kN/m. In some embodiments, a blown film made from the ethylene-based polymer can have a transverse direction (TD) Elmendorf Tear of 50 kN/m, 60 kN/m, 70 kN/m, or 80 kN/m to 90 kN/m, 95 kN/m, 100 kN/m, or 110 kN/m. In other embodiments, a blown film made from the ethylene-based polymer can have a tranverse direction Elmendorf Tear of 50 UN/m, 60 kN/m, 70 kN/m, or 80 kN/m to 85 kN/m, 87 kN/m, 90 kN/m, 93 kN/m, or 95 kN/m. In some embodiments, a blown film made from the ethylene-based polymer can have a transverse direction Elmendorf Tear of less than 95 kN/m, less than 93 kN/m, less than 90 kN/m, or less than 87 kN/m. The Elmendorf Tear of the blown film can be measured according to ASTM D1922-15 on a blown film specimen that has been conditioned for 40 hours at a temperature of 23° C.+/−2° C. and 50+/−10% relative humidity.

In some embodiments, a blown film made from the ethylene-based polymer can have an elongation at yield in the machine direction (MD) of 6.0%, 6.3%, 6.5%, 6.7%, or 7% to 7.5%, 7.7%, 8.0%, 8.3%, or 8.5%. In some embodiments, a blown film made from the ethylene-based polymer can have an elongation at yield in the transverse direction (TD) of 5.0%, 5.3%, 5.5%, 5.7%, or 6% to 6.5%, 6.7%, 7.0%, 7.3%, or 7.5%. In some embodiments, a blown film made from the ethylene-based polymer can have an elongation at break in the machine direction (MD) of 375%, 385%, 395%, or 405% to 415%, 425%, 435%, or 445%. In some embodiments, a blown film made from the ethylene-based polymer can have an elongation at break in the transverse direction (TD) of 525%, 545%, 560%, or 570% to 590%, 600%, 615%, 630%, or 640%. The elongation at yield and the elongation at break can be measured according to ASTM D-822-18, modified by using a 2.54 mm×17.78 cm strip at a speed of 50.8 cm/min.

In some embodiments, a blown film made from the ethylene-based polymer can have a dart drop impact strength of 33 g/μm, 35 g/μm, 37 g/μm, 39 g/μm, 41 g/μm, or 43 g/μm to 45 g/μm, 47 g/μm, 49 g/μm, 51 g/μm, or 53 g/μm. In other embodiments, a blown film made from the ethylene-based polymer can have a dart drop impact strength of greater than 37 g/μm, greater than 39 g/μm, greater than 41 g/μm, or greater than 42 g/μm to less than 53 g/μm, less than 52 g/μm, less than 50 g/μm, less than 48 g/μm, or less than 46 g/μm. The dart drop impact strength can be measured according to ASTM D-1709-16, Phenolic, Method A.

### Blends of Ethylene-Based Polymers

In some embodiments, the ethylene-based polymers described herein can be blended with another polymer component, particularly other alpha-olefin polymers such as polyethylene homopolymer and copolymer compositions (e.g., LLDPE, HDPE, MDPE, LDPE, and other differentiated polyethylenes) and/or polypropylene. The ethylene-based polymer can be present in such blends in an amount of 0.1 wt % to 99.9 wt %. The upper limit on the amount of ethylene-based polymer in such blends can be 99.5 wt %, 99 wt %, 98 wt %, 97 wt %, 96 wt %, 95 wt %, 90 wt % 85 wt %, 80 wt %, 75 wt %, 70 wt % 60 wt %, 50 wt %, 40 wt % 30 wt %, 25 wt %, 20 wt %, 15 wt %, 10 wt %, 5 wt %, 4 wt %, 3 wt %, 2 wt %, 1 wt %, or 0.5 wt %. The lower limit on the amount of ethylene-based polymer in such blends can be 99.5 wt %, 99 wt %, 98 wt %, 97 wt %, 96 wt %, 95 wt %, 90 wt %, 85 wt %, 80 wt %, 75 wt %, 70 wt %, 60 wt %, 50 wt %, 40 wt %, 30 wt %, 25 wt %, 20 wt %, 15 wt %, 10 wt %, 5 wt %, 4 wt %, 3 wt %, 2 wt %, 1 wt %, or 0.5 wt %. Blend compositions including any upper and lower limit of ethylene-based polymer are envisioned (e.g., 0.5 wt % to 99.5 wt %, 10 wt % to 90 wt %, 20 wt % to 80 wt %, 25 wt % to 75 wt %, 40 wt % to 60 wt %, 45 wt % to 55 wt %, 5 wt % to 50 wt %, 10 wt % to 40 wt %, 20 wt % to 30 wt %, 50 wt % to 95 wt %, 60 wt % to 90 wt %, 70 wt % to 80 wt %, 1 wt % to 15 wt %, 1 wt % to 10 wt %, 1 wt % to 5 wt %, 85 wt % to 99 wt %, 90 wt % to 99 wt %, or 95 to 99 wt %). The amount of ethylene-based polymer is based on the total weight of the polymer blend.

In some embodiments, the ethylene-based polymer can be blended with one or more propylene-based polymers (e.g., homopolymer, copolymer, or impact copolymer including >50 mol % of polymer units derived from propylene). In addition to blends having the compositional limits described above, particularly useful polypropylene-containing blends can include less than 50 wt % (e.g., 2 wt % to 49.5 wt %, 5 wt % to 45 wt %, 7.5 wt % to 42.5 wt % 10 wt % to 40 wt %, 20 wt % to 30 wt %, 25 wt % to 49.5 wt %, 30 wt % to 49.5 wt %, 35 wt % to 45 wt %) of the propylene-based polymer.

In some embodiments, polypropylene homopolymers or copolymers that can be used can have some level of isotacticity or syndiotacticity. In one embodiment, the polypropylene can be isotactic polypropylene, and in another embodiment, the polypropylene is highly isotactic polypropylene. In another embodiment, the propylene polymer can be a random copolymer, also known as an “RCP,” that can include propylene and up to 20 mol % of ethylene or a C₄ to C₂₀ olefin, preferably up to 20 mol % ethylene, preferably from 1 to 10 mol % ethylene.

The blends can be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process. Additionally, additives may be included in the blend, in one or more components of the blend, and/or in a product formed from the blend, such as a film, as desired. Such additives are well-known in the art, and can include, for example: fillers; antioxidants (e.g., hindered phenolics such as IRGANOX™ 1010 or IRGANOX™ 1076 available from BASF); phosphites (e.g., IRGAFOS™ 168 available from BASF); tackifiers, such as polybutenes, terpene resins, aliphatic and aromatic hydrocarbon resins, alkali metal and glycerol stearates and hydrogenated rosins; UV stabilizers; heat stabilizers; antiblocking agents; pigments; colorants; dyes; waxes; silica; fillers; talc and the like.

### EXAMPLES

The foregoing discussion can be further described with reference to the following non-limiting examples.

One inventive example (Ex. 1) and nine commercially available comparative examples (C1-C9) of ethylene-based polymers that included about 90 mol % to about 99 mol % of polymer units derived from ethylene and about 1 mol % to about 10 mol % of polymer units derived from one or more C₃ to C₁₈ α-olefin monomers were evaluated. C1-C4 are, respectively, Exact™ 3236, Exceed™ 1012, Exceed™ 2012, and Exceed™ 1018 ethylee-hexene copolymers, available from ExxonMobil Chemical. C5, C6, and C7 are, respectively, Elite™ AT 6401N, Elite™ 5400, and Affinity™ PL1880G ethylene-octene copolymers, available from Dow Chemicals. C8 and C9 are, respectively, Evolue™ SP0510 and SP1510 ethylene-hexene copolymers, available from Mitsui. Properties measured for the examples are shown in Table 1 below. Blown films having a thickness of 25.4 μm were made from the ethylene-based polymers of Ex. 1 and C1-C9 and properties measured for the blown films are shown in Tables 2-4 below. The blown films were made on a 160 mm blown film line with a 2.5:1 blow-up ratio, a melt temperature of 233° C., and a 1.52 mm die gap at a rate of 1.79 kg/hr/cm.

TABLE 1

| Property | Unit | Ex. 1 | C1 | C2 | C3 | C4 |
|---|---|---|---|---|---|---|
| Ethylene | mol % | 94.7 | 95.1 | 96.2 | 95.9 | 97.3 |
| Co- | mol % | 5.3 | 4.9 | 3.8 | 4.1 | 2.7 |
| monomer | | | | | | |
| Melt | g/10 | 0.70 | 1.90 | 1.07 | 1.98 | 0.99 |
| Index (I₂) | min | | | | | |
| Melt | g/10 | 12.07 | 31.24 | 16.93 | 32.56 | 15.24 |
| Index (I₂₁) | min | | | | | |
| Density | g/cm3 | 0.905 | 0.908 | 0.913 | 0.912 | 0.919 |
| Mn | g/mol | 48,403 | 36,316 | 41,708 | 36,090 | 40,273 |
| Mw | g/mol | 119,233 | 91,123 | 106,264 | 90,936 | 108,697 |
| Mz | g/mol | 210,163 | 159,435 | 188,758 | 162,067 | 198,185 |
| Intrinsic | dL/g | 1.76 | 1.45 | 1.65 | 1.47 | 1.73 |
| Viscosity | | | | | | |
| Viscosity | Pa · s | 3,009 | 1,797 | 2,489 | 1,799 | 2,661 |
| (Eta* at | | | | | | |
| 100 rad/s) | | | | | | |
| Viscosity | Pa · s | 7,279 | 3,255 | 5,258 | 3,149 | 5,631 |
| (Eta* at | | | | | | |
| 10 rad/s) | | | | | | |
| Viscosity | Pa · s | 10,288 | 3,802 | 6,688 | 3,645 | 7,064 |
| (Eta* at | | | | | | |
| 1 rad/s) | | | | | | |
| Viscosity | Pa · s | 11,245 | 3,919 | 7,057 | 3,752 | 7,406 |
| (Eta* at | | | | | | |
| 0.1 rad/s) | | | | | | |
| CDBI | % | 74.67 | 77.41 | 70.81 | 74.71 | 59.73 |
| T₇₅ − T₂₅ | ° C. | 17.2 | 15.9 | 13.5 | 14.1 | 11.6 |
| T_{w1} | ° C. | 56.1 | 57.3 | 66.6 | 64.1 | 77.6 |
| T_{w2} | ° C. | 78.4 | 77.6 | 83.8 | 82.4 | 88.8 |
| T_{w1} − T_{w2} | ° C. | −22.3 | −20.2 | −17.2 | −18.3 | −11.2 |
| M_{w1} | g/mol | 176,406 | 144,571 | 171,695 | 132,707 | 169,548 |
| M_{w2} | g/mol | 186,128 | 144,183 | 168,931 | 135,581 | 149,490 |
| M_{w1}/M_{w2} | | 0.9 | 1.0 | 0.24 | 0.23 | 0.24 |
| DRI/ | | 0.063 | 0.009 | 0.021 | 0.005 | 0.009 |
| Melt | | | | | | |
| Index (I₂) | | | | | | |

| Property | C5 | C6 | C7 | C8 | C9 |
|---|---|---|---|---|---|
| Ethylene | 96.6 | 96.7 | 95.1 | 94.1 | 95.9 |
| Co- | 3.4 | 3.3 | 4.9 | 5.9 | 4.1 |
| monomer | | | | | |
| Melt | 0.87 | 1.02 | 1.04 | 1.14 | 0.88 |
| Index (I₂) | | | | | |
| Melt | 18.29 | 30.45 | 30.73 | 21.24 | 15.60 |
| Index | | | | | |
| (I₂₁) | | | | | |
| Density | 0.912 | 0.916 | 0.903 | 0.906 | 0.913 |
| Mn | 28,673 | 28,673 | 40,535 | 35,686 | 35,245 |
| Mw | 103,402 | 103,402 | 87,306 | 105,521 | 114,826 |
| Mz | 259,562 | 259,562 | 152,493 | 210,224 | 224,219 |
| Intrinsic | 1.59 | 1.51 | 1.33 | 1.57 | 1.70 |
| Viscosity | | | | | |
| Viscosity | 2,243 | 1,533 | 1,560 | 2,042 | 2,419 |
| (Eta* at | | | | | |
| 100 rad/s) | | | | | |
| Viscosity | 5,327 | 3,954 | 3,850 | 4,559 | 5,672 |
| (Eta* at | | | | | |
| 10 rad/s) | | | | | |
| Viscosity | 8,567 | 7,758 | 7,478 | 6,011 | 7,675 |
| (Eta* at | | | | | |
| 1 rad/s) | | | | | |
| Viscosity | 10,289 | 11,062 | 10,861 | 6,412 | 8,239 |
| (Eta* at | | | | | |
| 0.1 rad/s) | | | | | |
| CDBI | 91.6 | 58.84 | 92.24 | 81.48 | 54.61 |
| T₇₅ − T₂₅ | 4.5 | 21.3 | 8.8 | 16.3 | 21.8 |
| T_{w1} | 72.6 | 63.4 | n/a | 51.7 | 62.7 |
| T_{w2} | 79.8 | 87.0 | n/a | 72.9 | 86.0 |
| T_{w1} − T_{w2} | −7.2 | −23.6 | n/a | −21.1 | −23.3 |
| M_{w1} | 100,888 | 196,780 | n/a | 154,633 | 186,416 |
| M_{w2} | 153,815 | 117,039 | n/a | 173,885 | 130,360 |
| M_{w1}/M_{w2} | 0.05 | 0.57 | n/a | 0.25 | 1.4 |
| DRI/ | 0.325 | 1.441 | 1.783 | 0.061 | 0.062 |
| Melt | | | | | |
| Index (I₂) | | | | | |

As shown in Table 1, the ethylene-based polymer of Ex. 1 had number average molecular weight (Mn) that was significantly greater than all the comparative examples. Similarly, the weight average molecular weight (Mw) of Ex. 1 was greater than all the comparative examples. The ethylene-based polymer of Ex. 1 also had a greater complex viscosity at a shear rate of 100 rad/s, 10 rad/s, 1 rad/s, and 0.1 rad/s as compared to all the comparative examples.

TABLE 2

| Property | | | Ex. 1 | C1 | C2 | C3 | C4 | C5 | C6 | C7 | C8 | C9 |
|---|---|---|---|---|---|---|---|---|---|---|---|---|
| Heat Seal | 70° | C. | 0.40 | n/a | n/a | n/a | n/a | n/a | n/a | n/a | 0.31 | n/a |
| Strength | 75° | C. | 4.54 | 0.58 | n/a | n/a | n/a | n/a | n/a | n/a | 2.31 | n/a |
| (N) | 80° | C. | 6.01 | 4.85 | n/a | n/a | n/a | n/a | n/a | 1.11 | 5.83 | n/a |
| | 85° | C. | 7.07 | 5.96 | 1.87 | 0.18 | n/a | 0.22 | 0.00 | 5.03 | 5.87 | 1.51 |
| | 90° | C. | 8.01 | 6.81 | 6.58 | 5.52 | n/a | 2.27 | 0.00 | 5.60 | 7.21 | 5.65 |
| | 95° | C. | 8.90 | 7.52 | 7.56 | 5.78 | n/a | 6.81 | 1.11 | 10.59 | 7.61 | 6.89 |
| | 100° | C. | 9.43 | 8.10 | 8.23 | 8.01 | 0.58 | 8.59 | 8.67 | 11.83 | 8.76 | 7.87 |
| | 105° | C. | 8.81 | 8.36 | 8.94 | 9.21 | 7.34 | 11.21 | 9.43 | 11.61 | 8.54 | 8.63 |
| | 110° | C. | n/a | n/a | 9.30 | 9.39 | 9.30 | 11.57 | 9.61 | n/a | n/a | 9.79 |
| | 115° | C. | n/a | n/a | 9.61 | 9.16 | 10.23 | 11.79 | 10.72 | n/a | n/a | 9.16 |
| | 120° | C. | n/a | n/a | n/a | n/a | 10.01 | n/a | 11.17 | n/a | n/a | 10.10 |
| | 125° | C. | n/a | n/a | n/a | n/a | 11.30 | n/a | 10.81 | n/a | n/a | n/a |

TABLE 3

| Property | | | Ex. 1 | C1 | C2 | C3 | C4 | C5 | C6 | C7 | C8 | C9 |
|---|---|---|---|---|---|---|---|---|---|---|---|---|
| Hot Tack | 70° | C. | 0.26 | n/a | n/a | n/a | n/a | n/a | n/a | n/a | 0.29 | n/a |
| Force | 75° | C. | 0.62 | 0.30 | n/a | n/a | n/a | n/a | n/a | n/a | 2.50 | n/a |
| (N/25 | 80° | C. | 1.56 | 0.66 | n/a | 0.21 | n/a | n/a | n/a | 0.41 | 4.78 | 0.26 |
| mm) | 85° | C. | 2.36 | 2.24 | 0.38 | 0.63 | n/a | n/a | 0.28 | 1.31 | 2.09 | 1.61 |
| | 90° | C. | 8.48 | 2.69 | 0.68 | 3.10 | n/a | 0.24 | 1.12 | 5.72 | 8.15 | 5.42 |
| | 95° | C. | 8.89 | 5.55 | 5.17 | 7.55 | 0.23 | 3.17 | 3.40 | 7.49 | 9.53 | 14.39 |
| | 100° | C. | 8.21 | 5.88 | 3.77 | 7.11 | 0.73 | 4.61 | 6.11 | 13.30 | 9.48 | 12.50 |
| | 105° | C. | 7.64 | 5.92 | 10.61 | 7.77 | 9.49 | 8.78 | 8.90 | 10.43 | 11.03 | 10.78 |
| | 110° | C. | n/a | 5.93 | 8.66 | 9.16 | 11.93 | 11.26 | 7.74 | 10.54 | 10.61 | n/a |
| | 115° | C. | n/a | 6.54 | 8.69 | 10.82 | 14.71 | 12.83 | 6.95 | n/a | 10.11 | n/a |
| | 120° | C. | n/a | 6.41 | n/a | 9.23 | 14.59 | 9.16 | 6.56 | n/a | n/a | n/a |
| | 125° | C. | n/a | 5.42 | n/a | 7.87 | 13.70 | 9.47 | n/a | n/a | n/a | n/a |

TABLE 4

| Property | Unit | Ex. 1 | C1 | C2 | C3 | C4 | C5 | C6 | C7 | C8 | C9 |
|---|---|---|---|---|---|---|---|---|---|---|---|
| Tensile | MPa | 5.5 | 5.3 | 6.7 | 6.3 | 9.1 | 7.1 | 8.6 | 5.2 | 5.0 | 6.8 |
| Yield Str | | | | | | | | | | | |
| (MD) | | | | | | | | | | | |
| Tensile | MPa | 5.2 | 5.1 | 6.6 | 6.3 | 9.6 | 6.9 | 8.9 | 4.7 | 4.4 | 6.5 |
| Yield Str | | | | | | | | | | | |
| (TD) | | | | | | | | | | | |
| Tensile | MPa | 80.4 | 68.5 | 66.4 | 71.4 | 69.2 | 55.3 | 57.7 | 67.8 | 76.5 | 50.6 |
| Break Str | | | | | | | | | | | |
| (MD) | | | | | | | | | | | |
| Tensile | MPa | 74.9 | 66.6 | 58.8 | 58.3 | 63.0 | 54.3 | 56.2 | 67.6 | 75.2 | 54.4 |
| Break Str | | | | | | | | | | | |
| (TD) | | | | | | | | | | | |
| Elong. at | % | 7.88 | 7.22 | 6.32 | 7.60 | 7.40 | 7.40 | 6.00 | 9.70 | 9.40 | 6.70 |
| Yield (MD) | | | | | | | | | | | |
| Elong. at | % | 6.72 | 6.62 | 5.78 | 9.30 | 8.50 | 6.30 | 6.00 | 9.20 | 7.80 | 5.30 |
| Yield (TD) | | | | | | | | | | | |
| Elong. at | % | 415 | 548 | 482 | 531 | 492 | 381 | 409 | 436 | 428 | 453 |
| Break (MD) | | | | | | | | | | | |
| Elong. at | % | 577 | 620 | 588 | 619 | 678 | 643 | 724 | 628 | 581 | 629 |
| Break (TD) | | | | | | | | | | | |
| Haze | % | 1.4 | 19.6 | 7.4 | >30 | 17.1 | 2 | 11.4 | 2.4 | 14.5 | 1.09 |
| Average | GU | 86.00 | 29.50 | 60.00 | 17.95 | 38.50 | 84.00 | 47.50 | 80.35 | 35.75 | 28.25 |
| Gloss | | | | | | | | | | | |
| Puncture | kN/m | 2,676 | 2,303 | 2,521 | 2,394 | 2,460 | 2,510 | 1,813 | 2,728 | 2,834 | 2,026 |
| Peak Force | | | | | | | | | | | |
| Puncture | kJ/m | 254 | 251 | 247 | 216 | 204 | 232 | 133 | 228 | 218 | 177 |
| Break | | | | | | | | | | | |
| Energy | | | | | | | | | | | |
| Elmendorf | kN/m | 41.9 | 79.3 | 63.8 | 97.7 | 107.0 | 94.1 | 74.9 | 59.6 | 49.6 | 72.4 |
| Tear(MD) | | | | | | | | | | | |
| Elmendorf | kN/m | 84.7 | 102.4 | 102.0 | 123.8 | 160.7 | 205.4 | 253.6 | 145.0 | 97.5 | 126.0 |
| Tear (TD) | | | | | | | | | | | |
| Dart Drop | g/um | 44 | 25 | 34 | 36 | 34 | 33 | 34 | 16 | 29 | 53 |

As can be seen from Tables 2-4, the blown film made from the polyethylene-based polymer of Ex. 1 had a peak heat seal strength at a significantly lower temperature, e.g., 75° C., as compared to C1-C9 that had a similar density while also maintaining satisfactory strength, e.g., puncture and tensile properties. The blown film made from the polyethylene-based polymer of Ex. 1 also had the lowest haze, the greatest average gloss, the greatest tensile break strength (MD), and the greatest puncture break energy out of all the examples.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having the benefit of this disclosure, will appreciate that other embodiments can be devised which do not depart from the scope and spirit of the present disclosure.

What is claimed is:

1. An ethylene-based polymer, comprising 90 mol % to about 99 mol % of polymer units derived from ethylene and 1 mol % to 10 mol % of polymer units derived from one or more C₃ to C₁₈ α-olefin monomers, wherein the ethylene-based polymer has:
a melt index (I₂, 190° C.) of 0.1 g/10 min to 10 g/10 min,
a density of 0.890 g/cm³ to 0.910 g/cm³,
a compositional distribution breadth index (CDBI) of 60% to 80%,
a number average molecular weight (Mn) of 25,000 g/mol to 53,000 g/mnol,
an intrinsic viscosity of 1.3 dL/g to 1.9 dL/g, and
one or more of the following:
a composition distribution breadth T₇₅-T₂₅ value, as measured by temperature rising elution fractionation (TREF), of at least 16.5° C. to 21° C.,
a complex viscosity measured at a shear rate of 10 rad/s of at least 5,700 Pa·s to 8,700 Pa·s, and
a complex viscosity measured at a shear rate of 0.1 rad/s of at least 11,100 Pa·s to 14,100 Pa·s.

2. The ethylene-based polymer of claim 1, wherein the ethylene-based polymer has an MW₁/Mw₂ value of 0.6 to 1.7.

3. The ethylene-based polymer of claim 1, wherein the ethylene-based polymer has a Tw₁-Tw₂ value of −7° C. to −25° C.

4. The ethylene-based polymer of claim 3, wherein the Tw₁-Tw₂ value is less than −22° C.

5. The ethylene-based polymer of claim 1, wherein the ethylene-based polymer has the following:
a complex viscosity measured at a shear rate of 100 rad/s of 1,500 Pa·s to 3,300 Pa·s, and
a complex viscosity measured at a shear rate of 1 rad/s of 3,600 Pa·s to 13,000 Pa·s.

6. The ethylene-based polymer of claim 1, wherein the ethylene-based polymer has a Dow Rheology Index (DRI)/melt index (I₂, 190° C.) ratio of greater than 0.060 to less than 0.080.

7. The ethylene-based polymer of claim 1, having one or more of the following:
(a) melt index (I₂, 190° C.) within the range from 0.5 g/10 min to 1 g/10 min;
(b) density within the range from 0.900 g/cm³ to 0.910 g/cm³;
(c) CDBI within the range from 70% to 80%;
(d) Mn within the range from greater than 42,000 to less than 50,000; and
(e) intrinsic viscosity within the range from greater than 1.6 dL/g to 1.9 dL/g.

8. The ethylene-based polymer of claim 7, having all of the properties (a)-(e).

9. The ethylene-based polymer of claim 1, wherein the ethylene-based polymer has the following:
a composition distribution breadth T₇₅-T₂₅ value, as measured by TREF, of at least 16.5° C. to 19° C.,
a complex viscosity measured at a shear rate of 100 rad/s of greater than 2,700 Pa·s to 3,100 Pa·s,
a complex viscosity measured at a shear rate of 10 rad/s of greater than 5,700 Pa·s to 8,200 Pa·s,
a complex viscosity measured at a shear rate of 1 rad/s of greater than 8,700 Pa·s to 12,000 Pa·s,
a complex viscosity measured at a shear rate of 0.1 rad/s of greater than 11,100 Pa·s to 13,500 Pa·s, and
a Dow Rheology Index (DRI)/melt index (I₂, 190° C.) ratio of greater than 0.060 and less than 0.080.

10. The ethylene-based polymer of claim 1, wherein a blown film made from the ethylene-based polymer has a hot tack force greater than 4 N/25 mm at a temperature between 85° C. and 90° C.

11. The ethylene-based polymer of claim 1, wherein a blown film made from the ethylene-based polymer has a seal strength of greater than 3 N at a seal temperature of 70° C. to 75° C.

12. An article comprising the ethylene-based polymer of claim 1.

13. The article of claim 12, wherein the article is in the form of a film or a pellet.

14. A blown film made from the ethylene-based polymer of claim 1, wherein the blown film has a seal strength of greater than 2 Newtons at a seal temperature of 70° C. to 100° C. or at a seal temperature of 72° C. to 75° C.

15. The blown film of claim 14, wherein the blown film has a hot tack force greater than 4 N/25 mm at a temperature between 85° C. and 90° C.

16. The blown film of claim 14, wherein the blown film has one or more of the following properties:
(A) a tensile break strength in a machine direction of 50 MPa to 85 MPa or greater than 78 MPa to 85 MPa;
(B) a haze of 1% to 20%;
(C) an average gloss of 10 GU to 90 GU;
(D) a puncture peak force per 25.4 μm of 1,800 kN/m to 3,000 kN/m or greater than 2,670 kN/m to 3,000 kN/m;
(E) a puncture break energy of 130 kJ/m to 260 kJ/m or greater than 252 kJ/m to 260 kJ/m; and
(F) MD Elmendorf Tear of 30 kN/m to 110 kN/m or 30 kN/m to less than 45 kN/m.

17. The blown film of claim 16, having all of the properties (A)-(F).

18. The blown film of claim 16, having one or more of the following:
(A1) tensile break in the machine direction (MD) of greater than 78 MPa to 85 MPa;
(B1) a haze of 1% to less than 2%;
(C1) average gloss of greater than 84 GU to 90 GU;
(D1) puncture peak force per 25.4 μm of greater than 2,670 kN/m to 3,000 kN/m;
(E1) puncture break energy of greater than 252 kJ/m to 260 kJ/m; and
(F1) MD Elmendorf Tear of 30 kN/m to less than 45 kN/m.

19. The blown film of claim 18, having all of the properties (A1)-(F1).

20. A process for making an ethylene-based polymer, comprising:
introducing ethylene and one or more C₃ to C₁₈ α-olefin monomers into a reactor; and
polymerizing the ethylene and the at least one other comonomer at a temperature of 50° C. to 110° C. and a pressure of 750 kPa-absolute to 7,000 kPa-absolute within the reactor to produce the ethylene-based polymer, wherein the ethylene-based polymer comprises 90 mol % to 99 mol % of polymer units derived from ethylene and 1 mol % to 10 mol % of polymer units derived from the one or more C₃ to C₁₈ α-olefin monomers, and wherein the ethylene-based polymer has:
a melt index (I₂, 190° C.) of 0.1 g/10 min to 10 g/10 min,
a density of 0.890 g/cm³ to 0.910 g/cm³,
a compositional distribution breadth index of 60% to 80%,
a number average molecular weight of 25,000 g/mol to 53,000 g/mol,
an intrinsic viscosity of 1.3 dL/g to 1.9 dL/g, and
one or more of the following:
a composition distribution breadth T₇₅-T₂₅ value, as measured by TREF, of at least 16.5° C. to 21° C.,
a complex viscosity measured at a shear rate of 10 rad/s of at least 5,700 Pa·s to 8,700 Pa·s, and
a complex viscosity measured at a shear rate of 0.1 rad/s of at least 11,100 Pa·s to 14,100 Pa·s.
